(19) United States
(12) Patent Application Publication
(10) Pub. No.: US 2008/0189031 A1
(43) Pub. Date: Aug. 7, 2008

(54) Methods and apparatus for presenting a continuum of image data

(76) Inventors: William D. Meadow, Jacksonville, FL (US); Randall A. Gordie, Augustine, FL (US)

Correspondence Address: Joseph P. Kincart, Esq., 8153 Middle Fork Way, Jacksonville, FL, 32256, US

(21) Appl. No.: 11/702,707

(22) Filed: Feb. 6, 2007

(51) Int. Cl. G01C 21/30

(52) U.S. Cl. 701/208; 340/995.1

(57) ABSTRACT

The present invention provides methods and apparatus for presenting one or more continuums of image data to a user. Typically, the continuum of image data will be presented via a graphical user interface. Portions of the continuum of image data can be correlated with geospatial data to indicate a particular location. In addition, a continuum of image data can be correlated with other images, such as an aerial view of a geographic area.

### CROSS REFERENCE TO RELATED APPLICATIONS

The present application claims priority to pending patent application Ser. No. 11/216,465, filed, Aug. 31, 2005 and entitled, “Apparatus and Method for Producing Video Drive-By Data Corresponding to a Geographic Location,” the contents of which are relied upon and incorporated by reference, and also the co-pending patent application filed concurrently with the present invention and entitled, “Methods and Apparatus for Generating a Continuum of Image Data.”

### FIELD OF THE INVENTION

The present invention relates to the methods and apparatus of presenting image data. More specifically, the present invention relates to mapping image two-dimensional image on the surface of a continuum.

### BACKGROUND OF THE INVENTION

Images of geographic areas created on a local basis have been created in numerous formats. Photographs, movie cameras, video camera recorders, and more recently digital recorders have all been utilized to capture images of a geographic parcel. Photographs can be useful because they are easily associated with a particular real estate parcel, however they are limited in the scope of the subject matter that they can include and must be manually docketed and presented in reference to a particular property. Panoramas can increase the scope of the subject matter captured and presented, but are limited by the point of capture of the panoramic views.

Movie pictures, video recorders and digital recorders and other “motion pictures” provide for increased scope of image capture. However, it is sometimes difficult to locate and view a particular portion of interest of images captured as motion pictures. In addition, correlation of particular portions of a motion picture with a particular real estate parcel can be difficult if the motion picture includes more than one real estate parcel. For example, it is relatively difficult to locate and view a particular real estate parcel in the context of its neighborhood setting, or particular aspects of its setting.

Aerial images, such as satellite pictures, of geographic areas have also been captured, specific parcels of land or landmarks can be located on the aerial images. However, prior to the present invention and its progeny, there has not been a mechanism for accurately correlating ground level images with substantial portions of an aerial image in a consistent and orderly format that allows for the identification of a particular parcel of land and provide both aerial and ground level views of the parcel, as well as a surrounding area of the parcel.

Although it would be highly useful to view several modalities of information through a single interface, prior to the present invention, there has not been a method for correlating geopolitical indicators, such as property lot lines, or tax map parcels with aerial images and orthogonal ground level video images or for presenting such correlations to an end user for the purpose of assessing real estate parcels and their surroundings.

### SUMMARY OF THE INVENTION

Accordingly, the present invention provides methods and apparatus for presenting a continuum of two-dimensional image data to a user. Preferred embodiments include providing a continuum of image data mapped on a polygon surface wherein the image includes two-dimensional image data of a geographical area captured at street level. The views are sometimes referred to as ribbon views.

Two-dimensional continuums of image data are generated from a plurality of image data sets, wherein each image data set is captured from a disparate point. Positional data is included that is descriptive of the location of one or more segments of the continuum of image data. The positional data can be utilized to link a particular portion of the continuum of image data to additional information related to a particular segment of the continuum of image data and to a high level interface that can be used to locate a particular portion of the continuum that may interest a user.

The high level interface that can facilitate a user's selection of area of interest can include, for example, an aerial view or a geo-data aware graphic with substantive differentiations between geographic parcels.

Some specific embodiments of the present invention provide for strips of image data that provide a street level view of a neighborhood as if the user were viewing the neighborhood through a side window of a vehicle traversing the streets of the neighborhood. A particular street address can be used to locate an area of interest, or a user can drill down through aerial view images or geo-aware view images to locate an area of interest. Textual data descriptive of a parcel in view can be presented to the user, at the user's request. In addition, user interface devices can be provided to facilitate a user accessing various segments of the two-dimensional image data from an interface that emulates driving along streets.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments:

FIG. 1 illustrates a presentation of a continuum of two-dimensional image data.

FIG. 2 illustrates a high level interface that can facilitate accessing a relevant portion of a continuum of image data.

FIG. 3 illustrates an intermediate view of a high level interface that may be used to facilitate access to a relevant portion of a continuum of image data.

FIG. 4 illustrates additional data that can be presented with image data of a selected geographic area.

FIG. 5 illustrates a continuum of image data aligned to an aerial image with polygon overlays.

FIG. 5A illustrates a canyon view including two continuums of image data aligned to an aerial image with polygon overlays.

FIG. 6 illustrates exemplary user interface that can be used in some embodiments of the present invention.

FIG. 7 illustrates an orthogonal view presentation of a continuum of two-dimensional image data.

FIG. 8 illustrates a rear view selected by a user interactive device.

FIG. 9 illustrates an exemplary geo-aware high level interface that can be utilized to access a relevant portion of a continuum of image data.

FIG. 10 illustrates profile cutaways indicating various shapes of surfaces onto which a continuum of image data may be mapped according to the present invention.

FIG. 11 illustrates apparatus that can be used to implement some embodiments of the present invention.

### DETAILED DESCRIPTION OF PREFERRED EMBODIMENTS

The present invention provides methods and apparatus for presenting continuums of image data generated through the combination of portions of multiple image data sets. Each image data set is captured from a disparate point on a continuum. Specific and detailed disclosure of methods and apparatus for generating a continuum of image data are disclosed in a separate and co-pending application filed concurrently with the present invention and entitled, “Methods and Apparatus for Generating a Continuum of Image Data,” the contents of which are incorporated herein by reference. The present invention provides novel methods and apparatus for presenting the unique continuums of image data disclosed in said concurrent patent application.

In some preferred embodiments of the present invention, the continuums of image data can be associated with a positional description, such as street address or Cartesian coordinates. Various embodiments can also include correlation between the continuums of image data and other images of a geographic area, such as, for example an aerial image. Image data captured from a continuum of points at street level can emulate a view out of the side window of a vehicle as it traverses a neighborhood. Street level continuums of two-dimensional images can be combined with aerial view images and presented to a user in a unified presentation.

In addition, in some embodiments, polygon overlays provide positioning reference to the images. The polygons can be overlaid upon the aerial and image continuums and can include for example indications of: property boundaries; school districts; neighborhood boundaries; water districts; municipalities; or other geopolitical markings.

### Definitions

As used herein, Video DriveBy™ refers to street level video data captured in multiple angles encompassing a 360° view.

As used herein, Video FlyBy™ refers to Aerial/Satellite oblique (angular) view images with polygon line views.

As used herein, RibbonView™ refers to a film strip like view of properties which stands up at approximately 90° from a flat or angled aerial/satellite ortho image map and provides direct-on front images of properties to be displayed.

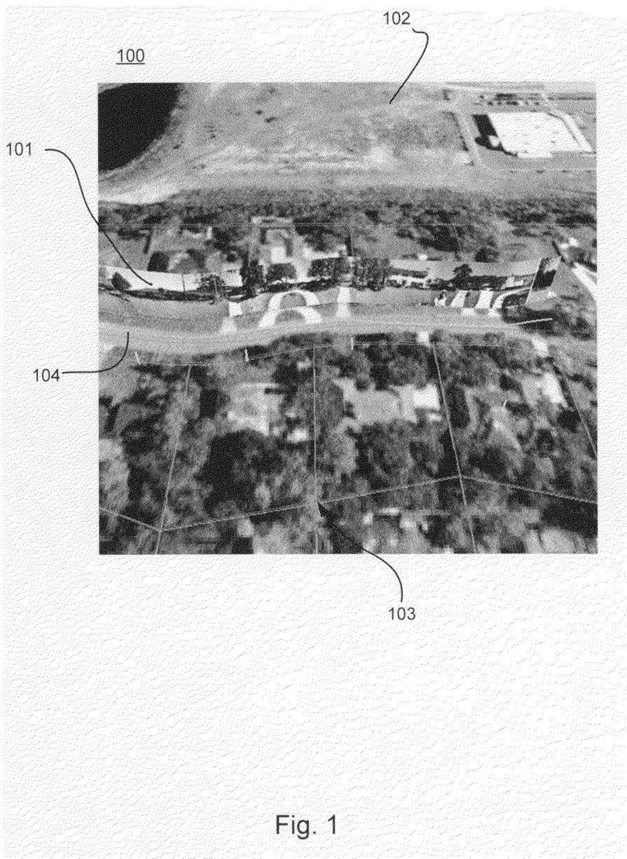

Referring now to FIG. 1, a basic example of a continuum of two-dimensional image data 101 is illustrated, aligned over an aerial image of a geographic area 102. The continuum of two-dimensional image data 101 can include a strip of image data with portions of image data sets aligned in a dimension consistent with a separate second continuum of points 104 from which the image data was captured. An image data set can include, for example, a digital photograph. Each image data set can be acquired from a different point along the second continuum 104 and provide orthogonal images of buildings or other improvements present in the geographic area, as well as driveways, trees, utility poles or other references.

In some embodiments, the present invention provides an indication of the second continuum as a path traveled 104 while capturing the image data sets. Typically, the illustrated path 104 will emulate a route driven by a vehicle performing Video DriveBy™ or by a person performing a Video Walkabout™.

According to the present invention, a continuum of two-dimensional image data 101 can be associated with positional data, such as, latitude and longitude coordinates. The latitude and longitude coordinates indicate a location of the image data sets used to form the continuum of two-dimensional image data 101. In addition, the positional data can be used to align the continuum of two-dimensional image data 101 with an aerial image 102 which acts as a background and contextual reference for the continuum of two-dimensional image data 101.

FIG. 1 also illustrates additional reference mechanisms in the form of polygons 103 overlaid upon the aerial image 102 and image continuum 101. As discussed above, the polygons 103 can be utilized to provide reference to external data, such as geopolitical designations including real estate property lines; school districts; neighborhoods; water districts; municipalities; voting districts; fire districts; hospital service lines; or other geopolitical markings.

According to the present invention, overlays can also be deployed in the form of graphical representation of other external information. For example, a graphical marker (not shown) may overlay one or more of the image continuum 101 and the aerial image 102, to reference points of demarcation, such as, fire hydrants, cable service, electrical service, mail boxes, traffic lights and the like. It should also be noted that overlays might be coded, such as by fill pattern or color coding, according to their purpose or according to the color of an image 101-102 over which they are laid in order to create contrast.

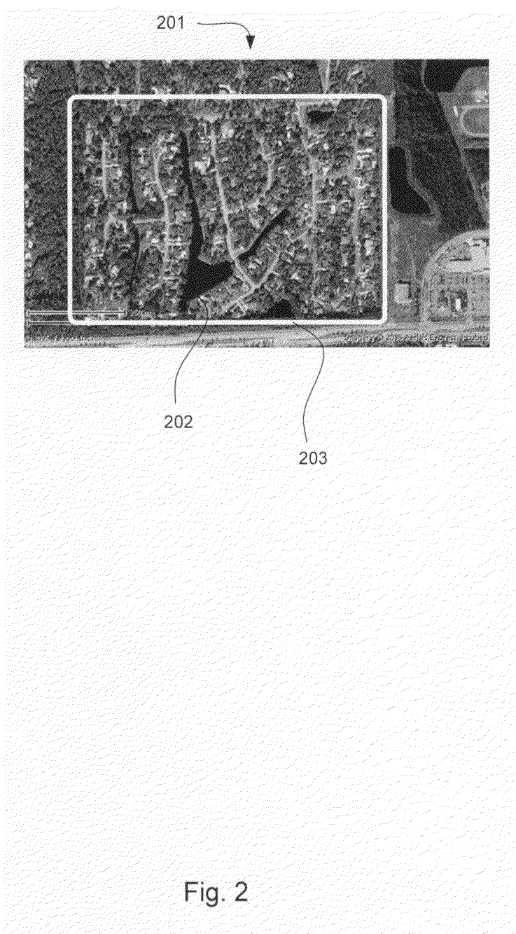

Some embodiments can also include presentation of an image continuum 101 that is preceded by mechanisms to assist a user in locating a particular image continuum 101 and a particular point of interest on the continuum, such as a street address located along the image continuum 101. Referring to FIG. 2, one such mechanism can include an aerial view image 201, which is provided to a user to assist the user in determining a particular geographic area or property to view. In some embodiments, multiple strips of image continuums 102 can be associated with an aerial view and hidden from a user interface until a predetermined zoom level of viewing is activated by the user. As illustrated in FIG. 2, a high level view can be presented to provide to a user representations of natural landmarks, such as a lake 202, which can be useful in identifying a particular geographic area. As discussed above, a polygon 203 can also be utilized as an overlay to designate an area, such as, for example a neighborhood. Utilizing polygon overlays and natural landmarks, a user can zoom into the aerial view image to identify one or more image continuums 101 that may be associated with the area.

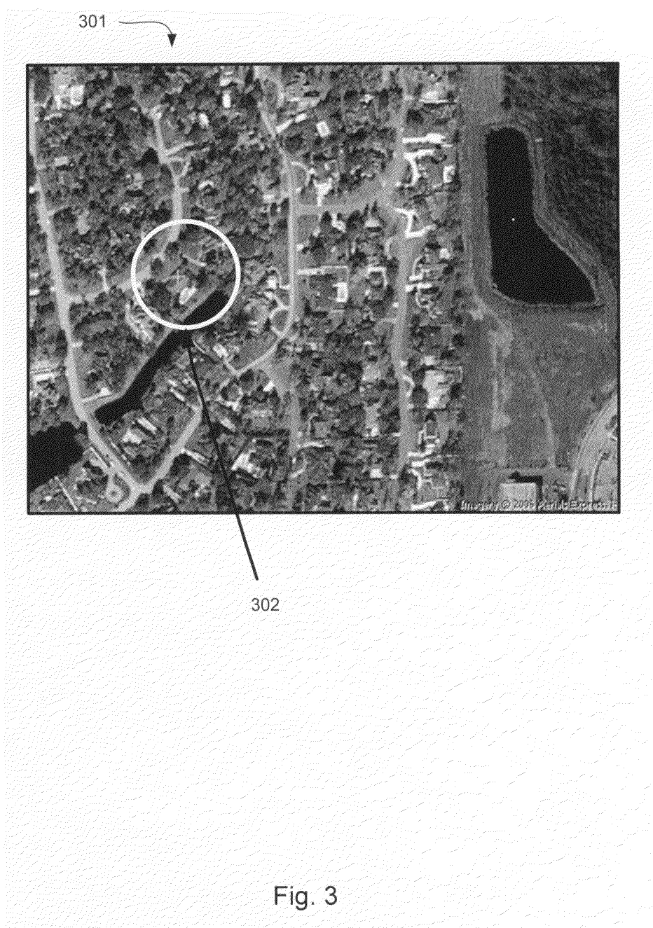

Continuing with the example, and referring now to FIG. 3, an aerial view image 301 is illustrated which further increases the zoom level and consequent detail available of a portion 301 of the larger aerial view image 201. In addition, with the availability of the additional detail in the aerial image view, a particular property 302 can be identified via metadata or other designation.

To be utilized as proficient tools for identifying areas of interest which have image continuums 101 associated with them, an aerial view 201 & 301 will include a view that is essentially 180° to the ground (as illustrated), or an oblique view at an angle other than 180° to the surface of the geographic area, but greater than 90°.

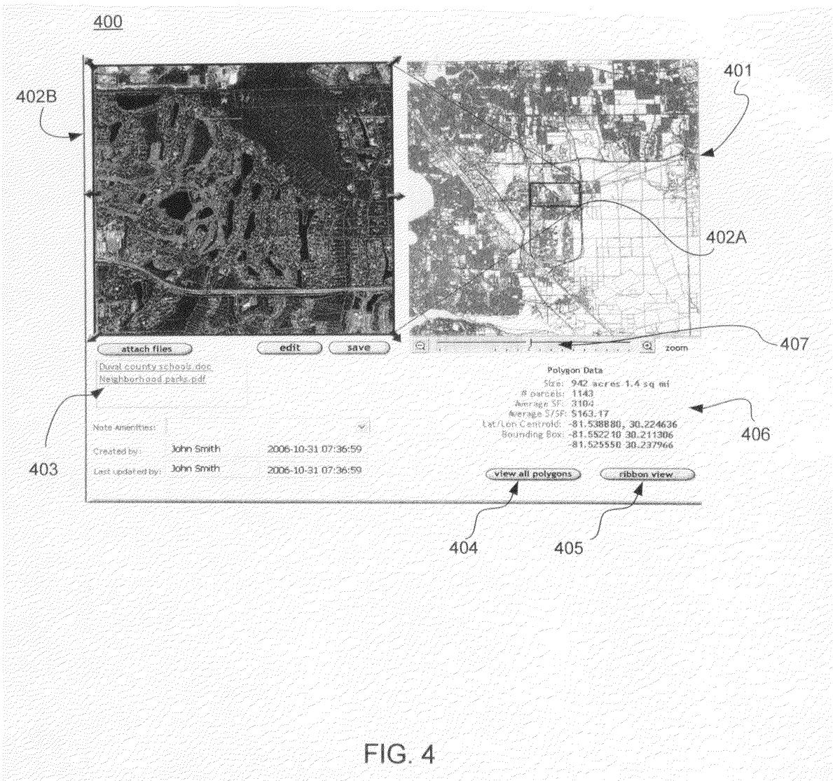

FIG. 4 provides an illustration of additional data that can be associated with a selected geographic area 402A-B and therefore with an image continuum 101 and aerial views descriptive of the selected geographic area 402A-B. Embodiments can include a series of polygons 401 in an aerial view image which transcend a particular view 402A-B and become more detailed and less detailed according to a zoom level chosen to view the image 402A-B. As illustrated, the polygons 401 include representations of property lines of real estate parcels. According to the present invention, polygons representative of other classes of data can also be made available, such as, through a user interface 403 which allows a user to select a set of polygons. By way of example, the polygons can include: school district lines and data; neighborhoods; neighborhoods amenities, such as parks, club houses or sport facilities; wireless signal strength map; delivery services; city government zoning; tax and property value data; population density; entertainment venues; road and travel data; golf courses; restaurants; law enforcement and fire rescue districts and almost any other data relevant to a geographic area.

A user interface can also include textual data 406, such as, by way of non-limiting example, the size and dimensions of a parcel of land, latitude and longitude coordinates, GPS positioning data; and boundary data. In another aspect, the user interface can include command buttons to view additional polygons 404 and to enter into a view including ribbon images 405.

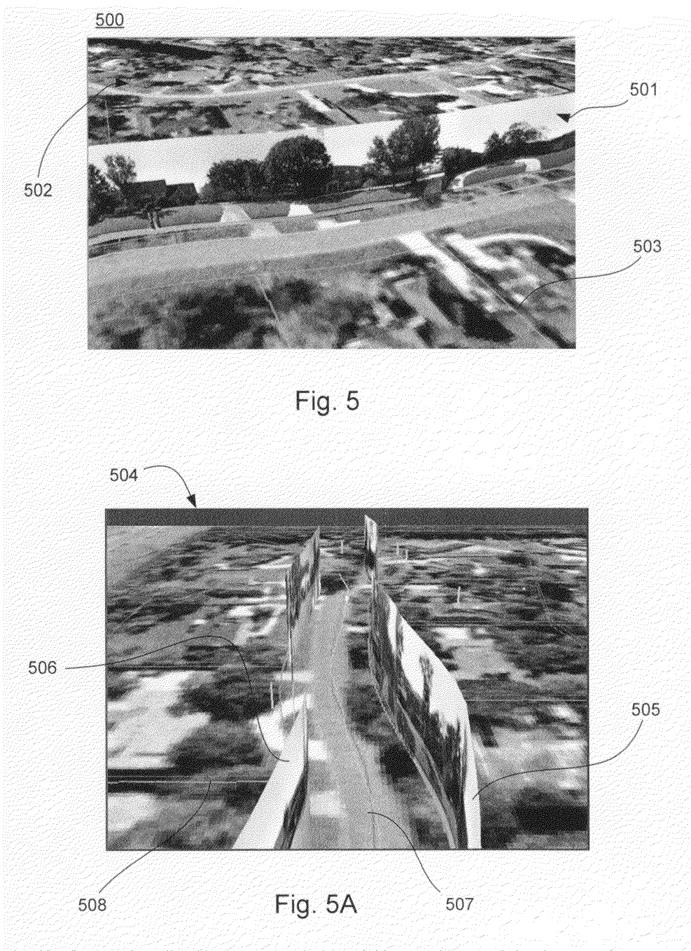

Referring now to FIG. 5, according to the present invention, further levels of zoom of an identified area of interest can present an aggregate of a ribbon view of a continuum of image data 501 captured at street level with the aerial view 502 and polygon overlays 503. The continuum of image data 501 overlaid on top of an aerial view 502 correlates image data captured at street level and contained in a continuum of data 501 with an aerial view image 502. Correlation can be according to any data that identifies the respective location of the two images, such as, for example latitude and longitude coordinates and global positioning satellite (GPS) data. In some preferred embodiments, the continuum of two-dimensional data 501 is presented perpendicular to the aerial view image 502. Other embodiments can include various angles of presentation.

Referring now to FIG. 5A, in some aggregate presentations of multiple views 504 can also include multiple continuums of image data 505-506 presented as ribbon views overlaid on an aerial view 509 creating a canyon effect as a user “navigates” along a roadway. Essentially, each continuum of image data 505-506 presented as a ribbon view provides an image which replicates an orthogonal view out of a car side window as the car drives past a parcels of property. FIG. 5A illustrates an additional embodiment of how polygon overlays 508 can be used to provide geospatial reference to the continuum of data 505-506 allowing a user to determine which portions of the continuum 505-506 correlate with which real estate parcels.

Similarly, a linear continuum can be illustrated 507 indicating points from which data was captured to create one or more of the continuums of image data 505-506. Typically, the linear continuum 507 includes a path traveled by a motor vehicle engaged in Video DriveBy™.

In another aspect, the present invention includes various methods of accessing a property such as, for example: a) navigating to the property via “flight” in an aerial view 502, locating the property and then transitioning to a ribbon view 501 which provides a street level view of the front of the property; or b) immediately locating a property via a geographic designation, such as, for example, latitude and longitude, tax map number, property meets and bounds description, or even property address.

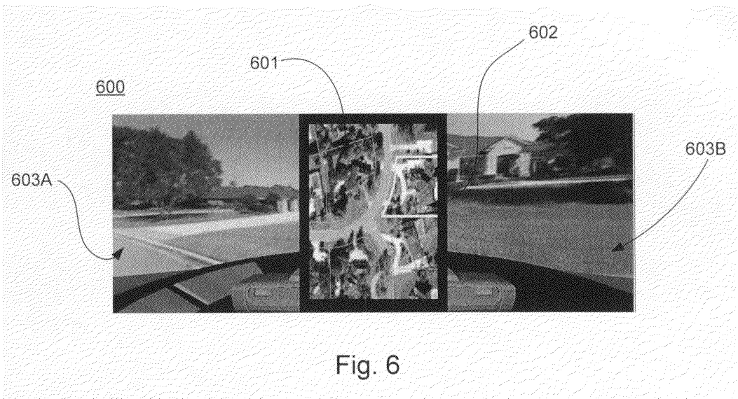

Referring now to FIG. 6, an exemplary user interface is illustrated which includes several aspects of property description and views aggregated into a single interface. The user interface 600 can include, for example, a window with an aerial view 601. Within the aerial view 601 can be included a polygon overlay 602 which identifies the boundaries of a property. Combined with the aerial view is a continuum of image data 603A-603B. As illustrated, the continuum of image data 603A-603B appears on either side of the window 601 and provides a street level image of a selected property. The interface 600 illustrated is analogous to sitting in a cockpit with an interactive view screen placed in front of the user and a continuum of image data 603A-603B in an orthogonal view through the “windshield”.

In some preferred embodiments, a SwivelPod™ Viewer includes a desktop resident application which enables such user interface aspects. The SwivelPod™ Viewer embodiments are designed to automatically fetch video, visuals and data in cycles as per the user's defined preferences. SwivelPod™ Viewer enables a targeted delivery of high resolution data, such as HDTV quality. In some embodiments, the viewer can also provide business partners with a medium suited to the inclusion of branding, informational, advertising and promotional marketing messages via text, audio or visual media.

While “in” the SwivelPod™ scene, user interface controls are available which “morph,” or otherwise change the scene viewed, to accommodate a user's intended action. SwivelPod™ thereby allows the user to fly over (FlyBy), drive by (DriveBy), or, in some embodiments, even walk around and through (WalkAbout) actual properties. In FlyBy mode, the user can move in any aerial direction to see properties and neighborhoods from either traditional top-down views (ortho) or angular (oblique) views that give a virtual horizon perspective. The RibbonView™ feature stands a “street strip” of home images captured with VideoDriveBy™ up at an angle, such as about 90 degrees from the horizontal content of the satellite image map. An indicator, such as, for example, a yellow line identifies an actual path 105 traveled by video capture system and another indicator, such as green parcel lines act as polygon overlays to identify property locations and boundaries.

In preferred embodiments, an image data capture system is functional to capture image data in a 360° panoramic via eight overlapping video camera angles. The video can be post-processed to blend each of the angles of view and thereby present sweeping 360° panoramas. The panoramas allow users to virtually “drive” a street segment or “walk” through a property. The 360° panoramic capture and the interface allow a user to swivel their angle of view in any direction on the computer screen as they progress on the virtual drive by or walk through, the property.

Visual services integrated into embodiments, such as SwivelPod™ are correlated to present a user a comprehensive overview of a geographic location, such as a residential property. The present invention integrates into one tool visual indications of a property's location in a neighborhood, as well as the property's location in relation associated amenities for viewing and traversing from computerized node, such as, for example, a personal computer, laptop or handheld device.

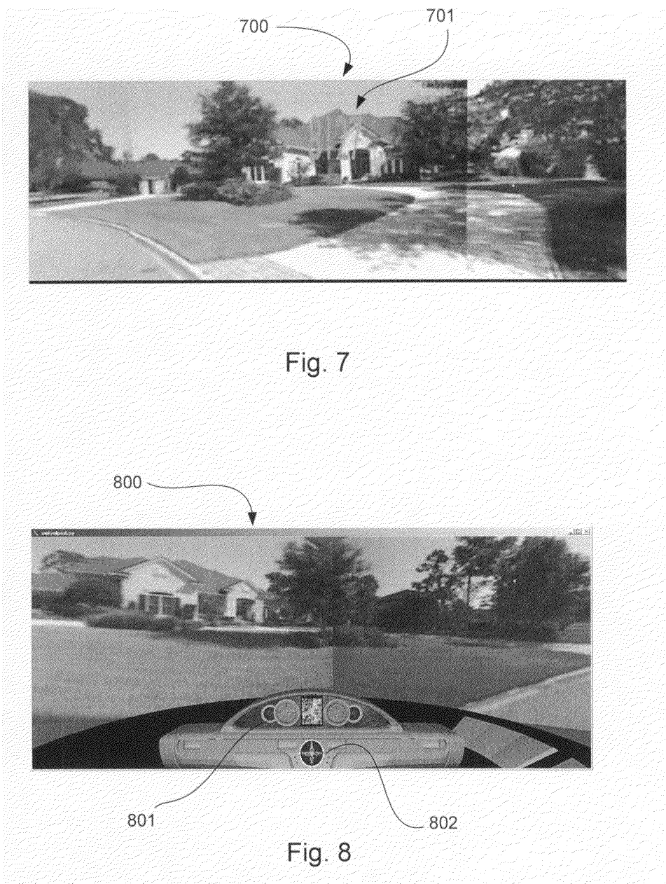

Referring now to FIG. 7, some embodiments of the present invention can include a VideoDriveBy mode whereby a user is presented with a panoramic “windshield view” 700 captured by two or more wide-angle cameras (not illustrated). In such embodiments a user can “drive” a path 105 of a vehicle from which a continuum of image data sets were captured. Some additional embodiments can provide the capability of a user to traverse a continuum of points from which image data sets were captured at graduated speeds, ranging, for example, from less than walking speed to speeds equivalent to 100 miles per hour or more. The virtual travel speed is limited more by the user's capability to ascertain where they are along a particular continuum of data than by the delivery rate of the captured image data.

Various embodiments of the present invention can enable a user to view a continuum of image data 603A-B while virtually mimicking the movement the driver of a vehicle is typically able to make wile driving a vehicle. Accordingly, embodiments can include movements relative to a virtual view 600 that slow down, stop and look around, virtually recreating the experience of driving by a property, with real image data correlating to the virtual movement. In addition, in some embodiments, multiple two-dimensional continuums of image data can virtually encompass a user, allowing the user to virtually travel in forward and reverse directions along a continuum traveled during data capture, while at the same time, virtually “swiveling in their seat” to gain a complete 360° visual representation of a viewed neighborhood.

A user view can also include geo-coded data 701, such as, for example, as illustrated, an address number of a property being viewed. As a user virtually traverses a street, the geo-coded data will change to correlate with specific properties being viewed. Other geo-coded data can include any type of data associated with the property being viewed. Examples therefore include: property address, current owners, lot size, building size, tax information, school district, municipality, commute time to a destination, age of buildings, price of a property, financing options, lien holders, lien status, prior purchase price, comparable properties, community information, or other information.

Some embodiments can also incorporate “geo-spatial assets” within a SwivelPod application, wherein content provider partners add control buttons to a SwivelPod dashboard that enables the partner to present customized views of provider specific data and branded or personalized video. In some embodiments, an open-source GIS platform can be maintained by developers and companies worldwide with a primary goal of interoperability of geo-coded data layers residing on different servers. Use of an open standard allows embodiments to access and display video and image data according to the present invention and simultaneously access and display geo-coded data real-time from third party servers in a unified and user configurable visualization environment.

Referring now to FIG. 8, an interface according to the present invention illustrates a continuum of two-dimensional image data view presented to a user in response to a user interactive command to swivel to a rear angle view 800 of a property. Generally, a rear angle view 800 a continuum of image data that compliments another continuum of image data by illustrating an alternate perspective. A user can be presented with user interactive devices 801 that enable a user to switch among various continuums of image data and emulate a driver of a vehicle looking out of various windows of a vehicle. In some embodiments, a device such as a virtual compass rose, can also be included in a user interface in order to indicate a view being presented to a user at a given instance, in some embodiments, also indicate other related image continuums that are available for viewing.

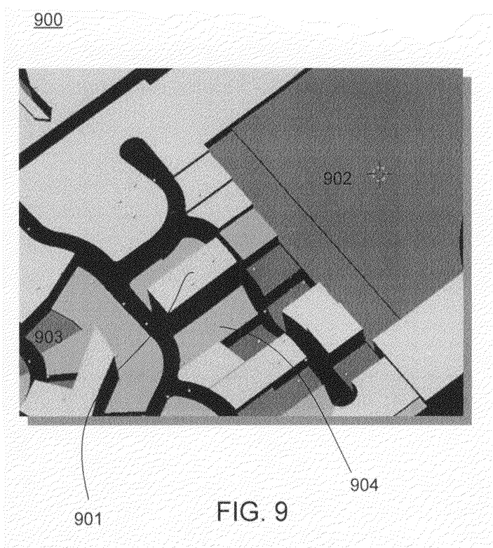

Referring now to FIG. 9, in another aspect of the invention, some embodiments can include a “geo-data aware” visualization application 900 as an initial interface through which a particular continuum of image data, or particular segment of a continuum of image data. The geo-data can include, for example, traditional real estate listing text data, that is seamlessly integrated with a continuum of image data and amenities data to provide a superior real estate search experience for home buyers. As opposed to simple aerial views, while in a high level mode, a geo-data aware user interface presents properties of interest with an intuitive visualization of complex data. In the example illustrated, the height of individual parcels 901-904 represents recent price transaction data, wherein higher transaction prices are represented by relative height of each respective parcel 901-904. Other embodiments 901-904 can include, for example; alternate patterns of properties, shading of properties, color coding properties, fill patterns, or other means of distinguishing attributes of a parcel. Using such devices, a high level introduction to a continuum of image data can be based upon almost any attribute of real estate parcels.

Accordingly, various embodiments can include a geo-data aware interface that introduces a continuum of image data based upon one or more of: parcel price, number of rooms, age of a home, square footage of a home, acreage in a parcel, flood zones, municipalities, school districts, real estate tax levels, utility availability, amenities available, or other attribute. For example, properties in “cool” colors such as green and blue can be less expensive on a per square foot basis, while those in yellow represent the higher cost per square foot.

Implementations of the present invention can include, by way of example, a potential real estate buyer seeking to assess available properties. During an initial assessment, a buyer may be presented with a large list of profiled properties that are currently on the market. Assuming that at any one time, approximately 3% of all properties are actively listed for sale on the real estate market a suburban area of medium density including, on average, 40,000 homes within a 5 mile radius, at a given time, about 1200 of those homes are for sale.

According to the present invention, a determination of homes that may interest a particular home buyer can be facilitated by first presenting a high level selection mechanism, such as, for example an aerial view or a geo-data aware interface, and using the high level selection mechanism to choose a segment of a continuum of two-dimensional image data with which a user may view a potential acquisition property from a street level perspective.

Proceeding with the example on the assumption that 5% of those homes meet a buyers specific requirements (price, size, amenities), at any one time, approximately 60 properties can be assessed to meet the potential buyer's requirements. Surveys of on-line habits of home buyers that have viewed homes on the internet indicate that such internet users tend to narrow their selections quickly to about 15-20 preferred properties which the home buyer consider actually visiting. Typically buyers are time-constrained in regards to critically examining all available property photos. In addition, previously available online data did not comprehensively include neighborhood information, essential to buyer selection of a property.

The present invention enables users to more quickly assess and narrow available properties for greater time efficiency, potentially saving both buyer and agent hours that would otherwise be spent driving to unappealing neighborhoods and visiting homes with incompatible amenities and yards.

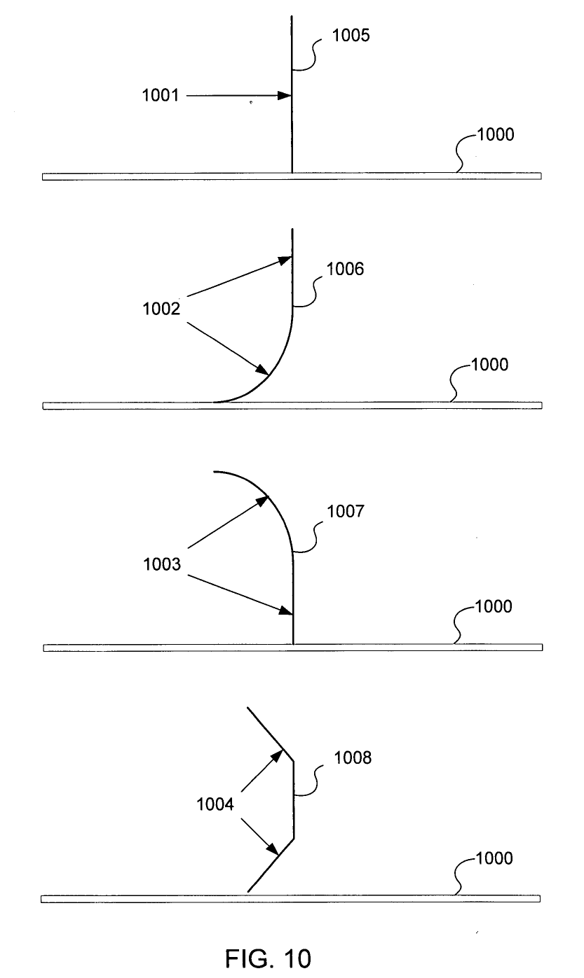

Referring now to FIG. 10, implementations of the present invention can include a continuum of image data 1001-1004 sprayed as a texture map on a polygon surface 1005-1008. FIG. 10 illustrates a profile, cutaway view which indicates the shape of a surface 1005 onto which image data 1001-1004 can be mapped. Some preferred embodiments include image data 1001 mapped on a surface 1005 that is generally linear and perpendicular to a surface representative of street level 1000. Other embodiments can include image data 1002 mapped on a surface 1006 with a radial portion proximate to the surface representative of street level 1000. Additional embodiments may include image data 1003 mapped on a surface 1007 with a radial portion at a distal end of the surface 1007 in relation to the surface representative of street level 1000. Still other embodiments may include image data 1004 mapped on an angular surface 1008. It is to be understood that the present invention is not limited by the shape of the surface onto which the image data 1001-1004 is mapped. In addition, in some embodiments, a user may select a shape of a polygon onto which the image data is mapped. Selection may be accomplished, for example, via a user interactive device or menu selection.

### Apparatus

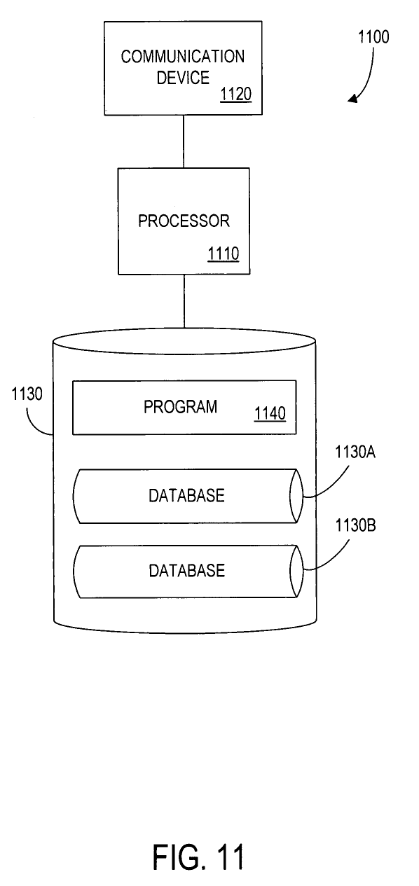

FIG. 11 illustrates a controller 1100 that may be utilized to implement some embodiments of the present invention. The controller 1100 comprises a processor unit 1110, such as one or more processors, coupled to a communication device 1120 configured to communicate via a communication network (not shown in FIG. 11). The communication device 1120 may be used to communicate, for example, with one or more devices, such as: a digital camera or other image data capture device, a personal computer, laptop or a handheld device.

The processor 1110 is also in communication with a storage device 1130. The storage device 1130 may comprise any appropriate information data storage mechanism, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 1130 can store a program 1140 for controlling the processor 1110. The processor 1110 performs instructions of the program 1140, and thereby operates in accordance with the present invention. The processor 1110 may also cause the communication device 1120 to transmit information. The storage device 1130 can additionally store related data in a database 1130A and database 1130B, as needed.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware can be implemented. Accordingly, other embodiments are within the scope of the following claims.

What is claimed is:

1. A method of presenting a continuum of two-dimensional image data, the method comprising:
generating a continuum of two-dimensional image data comprising a plurality of portions of image data sets, wherein each image data set is captured from a disparate point on a continuum and the portions are aligned in a dimension consistent with the continuum;
associating at least one segment of the continuum of two-dimensional image data with positional data descriptive of a location of the image data sets comprising the segment; and
presenting the at least one segment of the continuum of two-dimensional image data with the positional data in a human readable interface.

2. The method of claim 1 additionally comprising the step of:
presenting an aerial view of a geographic area as a two-dimensional surface;
aligning the at least one segment of the continuum of two-dimensional image data onto the aerial view of the geographic area, based upon the positional data; and
displaying the at least one segment of the continuum of two-dimensional image data at an angle to the two-dimensional surface formed by the aerial view.

3. The method of claim 2 wherein the angle of display of the continuum of two-dimensional image data to the two-dimensional surface formed by the aerial view is about perpendicular.

4. The method of claim 3 wherein the aerial view image comprises an orthogonal view of the geographic area.

5. The method of claim 3 wherein the aerial view image comprises an oblique view of the geographic area.

6. The method of claim 2 wherein the image data comprises a real estate parcel and the positional data comprises a geospatial designation.

7. The method of claim 6 wherein the geospatial designation comprises a street address.

8. The method of claim 6 wherein the geospatial designation comprises latitude and longitude coordinates.

9. The method of claim 6 wherein the disparate points in a continuum comprise positions of a vehicle traveling on a roadway.

10. The method of claim 6 additionally comprising the step of displaying metadata descriptive of the segment of the continuum of two-dimensional data.

11. The method of claim 6 additionally comprising the step of overlaying user interactive links to additional data related to the segment of the two-dimensional continuum.

12. The method of claim 11 additionally comprising the step of linking the additional data to the segment of two-dimensional image data based upon the positional data.

13. The method of claim 2 additionally comprising the steps of:
processing data comprising the aerial view to ascertain reference points within the aerial view;
processing data comprising the continuum of two-dimensional image data to generate street level reference points;
correlating at least some of the reference points within the aerial view with the street level reference points; and
overlaying the continuum of two-dimensional image data onto the aerial view based upon the correlation of the reference points within the aerial view and the street level reference points.

14. The method of claim 2 additionally comprising the steps of:
generating a first continuum of two-dimensional image data and a second continuum of two-dimensional image data, each of the two-dimensional continuums of image data comprising portions of image data sets captured from a disparate point on a continuum and the portions are aligned in a dimension consistent with the continuum; and
aligning the first two-dimensional continuum and the second continuum of two-dimensional image data onto the aerial view of the geographic area to form a canyon view of two-dimensional data imposed over the aerial view of geographic data.

15. The method of claim 14 additionally comprising the steps of:
displaying a user interactive device operative to receive an instruction to display an orthogonal view of one of: the aerial view, the first continuum of two-dimensional image data and the second continuum of two-dimensional image data; and
displaying an orthogonal view responsive to an indication received from the user interactive device.

16. The method of claim 2 additionally comprising the steps of:
displaying a user interactive device operative to receive an instruction to receive a street address; and
displaying a segment of one of the continuum of two-dimensional image data comprising image data of the street address.

17. The method of claim 16 additionally comprising the steps of generating an overlay of polygons dividing the geographic area into multiple parcels.

18. The method of claim 17 wherein each parcel is indicative of a geopolitical boundary.

19. The method of claim 18 wherein each geopolitical boundary comprises a tax map parcel.

20. The method of claim 18 additionally comprising the step of displaying metadata associated with the street address.

21. The method of claim 20 wherein the metadata is descriptive of one or more of: fire plugs; street signs, utility areas; building attributes; store locations; and a price range for a real estate parcel.

22. The method of claim 14 additionally comprising the step of providing a user interface capable of:
selecting one of the first continuum of image data, the second continuum of image data; and
traversing the length of a selected first continuum of image data or the second continuum of image data.

23. The method of claim 22 wherein the user interface is additionally operative to select the aerial image and traverse one or both of the length and width of the aerial image.

24. The method of claim 23 additionally comprising the step of displaying a user interactive device operative to control a rate of acceleration past image data presented in one or both of the first continuum of image data and the second continuum of image data.

25. A method of presenting image data of a geographic area, the method comprising:
receiving a geospatial designation descriptive of the geographic area;
associating a portion of a continuum of two-dimensional image data with the geospatial designation, wherein the continuum of two-dimensional image data comprises a plurality of portions of image data sets, wherein each image data set is captured from a disparate point on a continuum and the portions are aligned in a dimension consistent with the continuum; and
transmitting the portion of the continuum of two-dimensional image data comprising the geographic area.

26. The method of claim 25 wherein the data descriptive of a geospatial designation comprises a street address and the method further comprises the steps of:
associating the street address with latitude and longitude coordinates;
locating the latitude and longitude coordinates in metadata associated with portions of the continuum of two-dimensional image data; and
designating those portions of the continuum of two-dimensional image data comprising the located latitude and longitude coordinates for transmission.

27. The method of claim 26 additionally comprising the step of:
mapping the continuum of two-dimensional image data onto a surface generally perpendicular to a surface representing street level.

28. The method of claim 26 additionally comprising the step of:
mapping the continuum of two-dimensional image data onto a surface with a radial portion proximate to a surface representing street level.

29. The method of claim 26 additionally comprising the step of:
mapping the continuum of two-dimensional image data onto a polygonal surface proximate to a surface representing street level.

30. The method of claim 26 additionally comprising the step of:
mapping the continuum of two-dimensional image data onto a polygonal surface proximate to a surface representing street level, wherein the shape of the polygonal surface is selectable by a user.
